(19) United States
(12) Patent Application Publication
(10) Pub. No.: US 2025/0291834 A1
(43) Pub. Date: Sep. 18, 2025

(54) INFORMATION PROCESSING SYSTEM, INFORMATION PROCESSING METHOD, AND STORAGE MEDIUM

(71) Applicant: NEC Corporation, Tokyo (JP)

(72) Inventors: Takafumi KAKUWA, Tokyo (JP); Hidemi Hisamoto, Tokyo (JP)

(73) Assignee: NEC Corporation, Tokyo (JP)

(21) Appl. No.: 19/001,908

(22) Filed: Dec. 26, 2024

(30) Foreign Application Priority Data
Mar. 14, 2024 (JP) 2024-040032

(51) Int. Cl. G06F 16/38; G06F 16/383; G06F 16/58

(52) U.S. Cl. CPC G06F 16/382; G06F 16/383; G06F 16/5866

(57) ABSTRACT

An information processing system detects a transcription of citation information to a creation, and stores evidence information indicating an evidence of the citation information in a case where the transcription is detected.

### CROSS-REFERENCE TO RELATED APPLICATIONS

This application is based upon and claims the benefit of priority from Japanese patent application No. 2024-040032, filed on Mar. 14, 2024, the disclosure of which is incorporated herein in its entirety by reference.

### TECHNICAL FIELD

The present disclosure relates to an information processing system, an information processing method, and a storage medium.

### BACKGROUND ART

With the practical application of new technologies such as generative AI, fake information that is difficult to distinguish from the truth has flooded the Internet, making it difficult to verify the accuracy and credibility of information. A technology related to this application is disclosed in Japanese Unexamined Patent Application, First Publication, JP2023-148960A (Patent Document 1).

### SUMMARY

Patent document 1 discloses a technology for an information processing method that performs tamper-proof processing on satellite data.

In relation to such technologies, there has been a need for technology to improve the authenticity of citation information transcribed into creations such as reports.

An example object of the present disclosure is to provide an information processing system, a processing method, and a storage medium storing a program that solve the above-mentioned problems.

An information processing system according to one example aspect of the present disclosure detects the transcription of citation information to a creation, and stores evidence information indicating the evidence of the citation information in a case where the transcription is detected.

An information processing device according to one example aspect of the present disclosure compares, in a case where a request to view the creation is received, a hash value generated by inputting predetermined information included in the citation information transcribed to the creation into a hash function, with a stored hash value, to output a determination result of the evidence.

An information processing method according to one example aspect of the present disclosure, is one in which an information processing system detects the transcription of citation information to a creation, and stores evidence information indicating the evidence of the citation information in a case where the transcription is detected.

A non-transitory storage medium storing a program according to one example aspect of the present disclosure causes a computer of an information processing device to execute detecting the transcription of citation information to a creation, and storing evidence information indicating the evidence of the citation information in a case where the transcription is detected.

### BRIEF DESCRIPTION OF THE DRAWINGS

FIG. 1 is a diagram showing an overview of the processing of an information processing system according to some example embodiments of the present disclosure.

FIG. 2 is a diagram showing the relationship between an information processing system and a terminal according to some example embodiments of the present disclosure.

FIG. 3 is a diagram showing the hardware configuration of an information processing device according to some example embodiments of the present disclosure.

FIG. 4 is a functional block diagram of an information processing device according to some example embodiments of the present disclosure.

FIG. 5 is a first diagram showing an example of a report according to some example embodiments of the present disclosure.

FIG. 6 is a second diagram showing an example of a report according to some example embodiments of the present disclosure.

FIG. 7 is a first diagram showing the processing flow of an information processing system according to some example embodiments of the present disclosure.

FIG. 8 is a second diagram showing the processing flow of an information processing system according to some example embodiments of the present disclosure.

FIG. 9 is a third diagram showing the processing flow of an information processing system according to some example embodiments of the present disclosure.

FIG. 10 shows an example of an information processing device with another configuration according to some example embodiments of the present disclosure.

FIG. 11 is a diagram showing another configuration of an information processing device according to some example embodiments of the present disclosure.

FIG. 12 is a diagram showing the processing flow of an information processing device in another example according to some example embodiments of the present disclosure.

### EXAMPLE EMBODIMENT

The following describes an information processing system according to some example embodiments of the present disclosure.

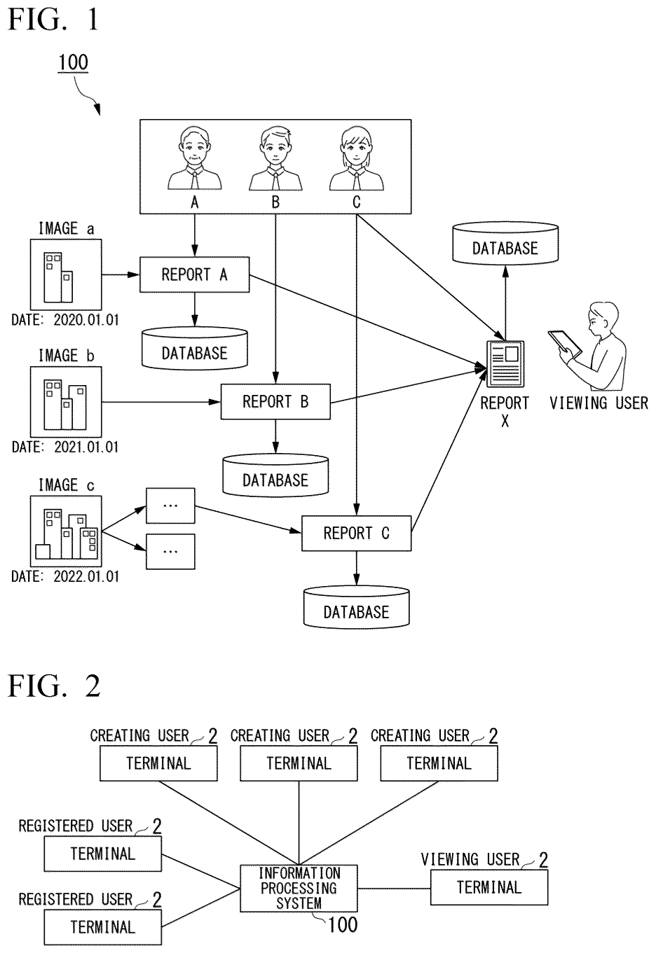

FIG. 1 is a diagram showing an overview of the processing of the information processing system.

As shown in FIG. 1, an information processing system 100 is used by multiple users. In the information processing system 100, many images such as image a, image b, and image c, which are citation information, are recorded in a database as an example. These images may be satellite images. User A, user B, and user C create using images registered in the database. A report created by user A is called report A, a report created by user B is called report B, and a report created by user C is called report C. It is assumed that user A, user B, and user C belong to different companies or organizations. These reports A, B, and C may be stored in one predetermined database, or may be distributed and stored in a plurality of databases. It is also assumed that report X, which cites reports A, B, and C and transfers some or all of the information, is created and stored in the database of the information processing system 100. A viewing user can view these reports. During viewing, the terminal displaying report X outputs evidence information indicating the evidence of the citation information transcribed in report X and the result of the determination of the evidence information, in a manner that is recognizable to the viewing user.

FIG. 2 is a diagram showing the relationship between the information processing system and the terminals.

The information processing system 100 is connected to and communicates with a terminal 2 used by a creating user who creates a report, a terminal 2 used by a registered user who registers citation information such as images to be transcribed in a creation such as a report, and a terminal 2 used by a viewing user who views a creation such as a report, and the like. The information processing system 100 may be composed of one or more information processing devices 1.

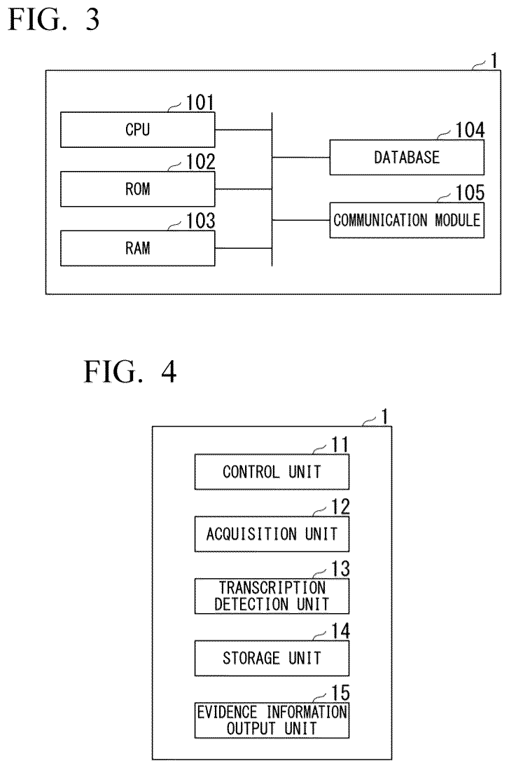

FIG. 3 is a hardware configuration diagram of the information processing device.

As shown in FIG. 3, the information processing device 1 is a computer equipped with various hardware components such as a CPU (Central Processing Unit) 101, a ROM (Read Only Memory) 102, a RAM (Random Access Memory) 103, a database 104, and a communication module 105. In a case where the information processing system 100 is composed of multiple information processing devices 1, each information processing device 1 may be composed of a single computer, or multiple computers may be communicatively connected and configured as an information processing device 1 as a whole. Moreover the terminals 2 are also computers equipped with the same hardware configuration as the information processing device 1. The terminals 2 may be a PC, a smartphone, or the like.

FIG. 4 is a functional block diagram of the information processing device.

The computer of the information processing device 1 executes a management program. As a result, the information processing device 1 performs the functions of a control unit 11, an acquisition unit 12, a transcription detection unit 13, a storage unit 14, and an evidence information output unit 15. Any of these functions may be included in the terminal 2. One or more of these functions may be distributed to different computers.

The control unit 11 controls each function.

The acquisition unit 12 acquires information.

The transcription detection unit 13 detects transcription of citation information to a creation.

The storage unit 14 stores evidence information indicating the evidence of the citation information in a case where transcription is detected.

The evidence information output unit 15 outputs evidence information indicating the evidence of the citation information included in a creation, in a case where a request to view the creation is acquired.

In this disclosure, the citation information is an image, another report, or a news article. Moreover in this disclosure, the creation is document data of a report. Furthermore, in this disclosure, the evidence information may be the time when the citation information was created (such as the date and time an image was taken, the date and time of creating a news article, or the date and time of creating another report), or a hash value of information related to the citation information. Moreover the evidence information may be stored in a blockchain.

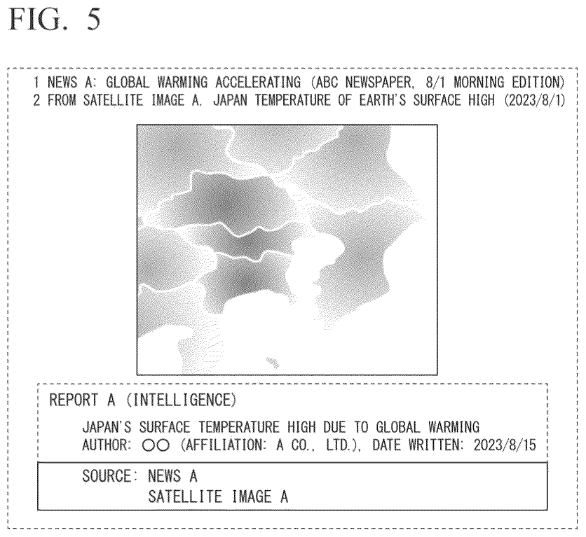

FIG. 5 is a first diagram showing an example of a report.

Report A is a report created by a certain user, and includes information on a news article A1 published in the morning edition of ABC Newspaper on August 1, and information on a satellite image A2 sent from a satellite on Aug. 1, 2023. The information processing device 1 saves the specified information in report A as evidence information. For example, the information processing device 1 stores in report A as intelligence information, text information indicating that “the earth's surface temperature is high due to the effects of global warming” quoting news A1, the name of the person who wrote it, the organization to which the person belongs, the date of writing, satellite image A2, identification information of the citation source, and other information as evidence information. The information processing device 1 may record a hash value of the predetermined information in report A in a predetermined storage device. The predetermined storage device may be a database or a blockchain.

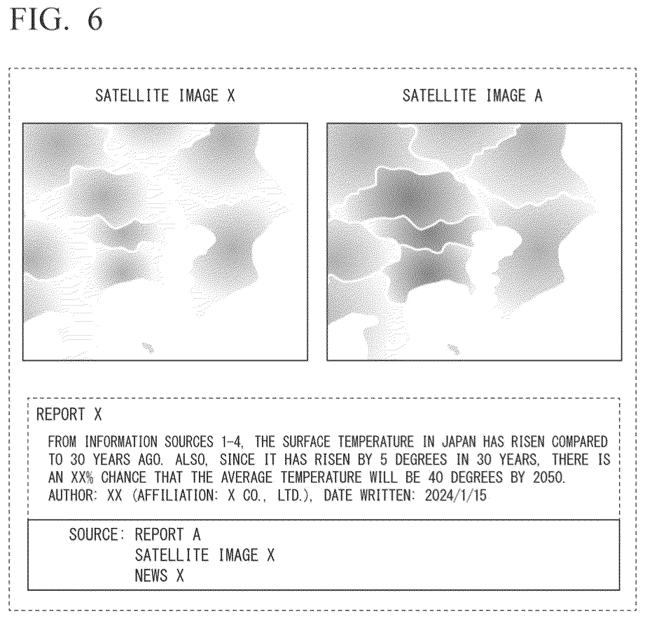

FIG. 6 is a second diagram showing an example of a report.

Report X is a report created by a certain user x, and includes information on report A shown in FIG. 5, as well as information on news X1 and satellite image X2 newly added by user x. The information processing device 1 saves the predetermined information in report X as evidence information. For example, the information processing device 1 stores, as intelligence information in the report X, information citing the report A, text information indicating that “the temperature in Japan has risen compared to 30 years ago according to the information source”, text information indicating that “since it has risen by 5 degrees in 30 years, there is an XX % possibility that the average temperature will be 40 degrees in 2050”, and information such as the name and organization of the person who wrote it, the date of writing it, the satellite image X2, and the identification information of the citation source and other information, as evidence information. The information processing device 1 may record a hash value of the predetermined information in the report X in a predetermined storage device. The predetermined storage device may be a database or a blockchain.

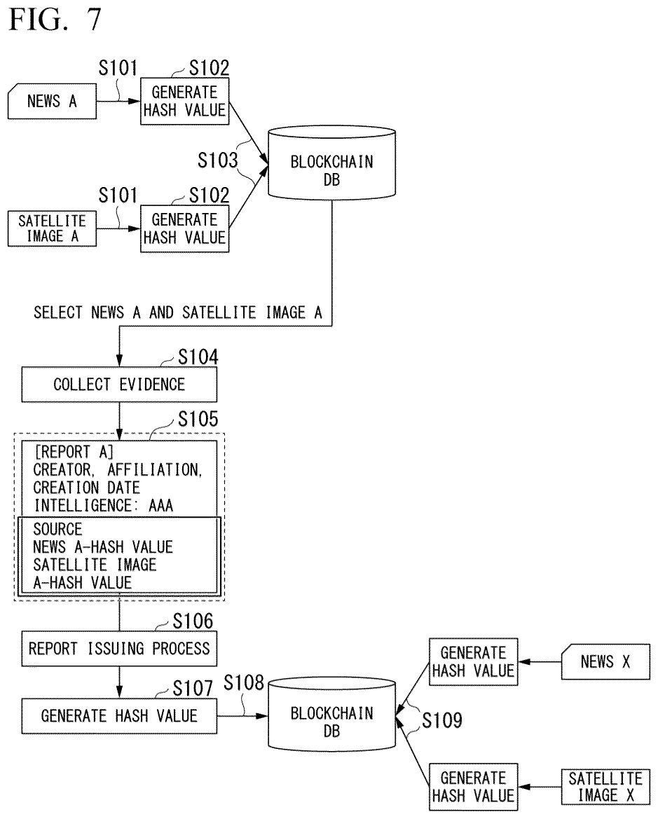

FIG. 7 is a first diagram showing the processing flow of the information processing system.

First, a registered user registers citation information such as news A or satellite image A in a predetermined storage destination (step S101). At this time, the acquisition unit 12 of the information processing device 1 acquires the citation information and outputs it to the storage unit 14. The storage unit 14 generates a hash value of the citation information (step S102). The storage unit 14 registers the hash value of the citation information in the storage destination (step S103). The storage destination of the hash value may be a blockchain or a specified database. Furthermore, the data of news A and satellite image A may be linked to the identification information of the citation information, and stored in a storage destination such as a database different from the hash value. The hash value storage destination may record the identification information of the citation information (such as a name or ID) in association with its hash value.

The creating user creates report A using a terminal 2. The terminal 2 accesses the information processing device 1. Furthermore, information processing device 1 may have a web page distribution function that outputs page information to terminal 2. The control unit 11 of information processing device 1 accepts the designation of the identification information of the citation information to be transcribed into report A from terminal 2. The acquisition unit 12 collects hash values that are the evidence information of the citation information from a storage destination such as a blockchain using the identification information of the citation information as a key (step S104). For example, the acquisition unit 12 acquires the hash value of news A and the hash value of satellite image A. The terminal 2 acquires these hash values.

The terminal 2 creates report A using a document creation function or the like based on the user's report creation operation (step S105). At this time, the terminal 2 embeds the hash value of news A, which is the evidence information, and the hash value of satellite image A in report A based on the user's operation. Moreover the terminal 2 also saves text information, name, affiliation, and creation date information in report A as intelligence information based on the user's operation. The terminal 2 transmits the data of report A and the identifier of report A to the information processing device 1. In a case where the control unit 11 of the information processing device 1 completes the creation of report A based on the user's operation, it performs a report issuing process (step S106). The control unit 11 instructs the transcription detection unit 13 to detect transcription. The transcription detection unit 13 detects the transcription of citation information into the report based on the hash value included in the data of report A and the acquisition of user operations. For example, transcription may be detected by acquiring information from the terminal 2 as to whether the user has transcribed citation information. In a case where the transcription detection unit 13 detects the transcription of citation information into the report, it generates a hash value of report A (step S107). The processing of the information processing device 1 may be performed inside the terminal 2. The storage unit 14 links the identification information of report A with the hash value, and stores it in the database or blockchain, which is the storage destination (step S108). The storage unit 14 may also store the data of report A in a storage destination such as a database different from the hash value, linking it with the identification information of the citation information of the report A. It is assumed that the identification information of news X and satellite image X and their hash values are also recorded in the database or blockchain that is the storage destination (step S109).

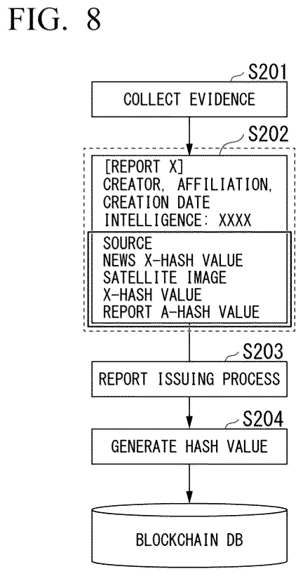

FIG. 8 is a second diagram showing the processing flow of the information processing system.

Next, it is assumed that another user x creates report X. In this case, it is assumed that user x transcribes part of the information of report A into report X. In this case, the terminal 2 used by user x also accesses the information processing device 1. The control unit 11 of the information processing device 1 accepts the designation of the identification information of the citation information to be transcribed into report X from the terminal 2. The acquisition unit 12 collects the hash value, which is the evidence information of the citation information, from the storage destination such as the blockchain, using the identification information of the citation information as a key. For example, the acquisition unit 12 acquires the hash value of news X, the hash value of satellite image X, and the hash value of report A. The terminal 2 acquires these hash values.

The terminal 2 creates report X using a document creation function or the like based on the report creation operation of user x (step S201). At this time, the terminal 2 embeds the hash value of news X, the hash value of satellite image X, and the hash value of report A, which are the evidence information, in report X, based on the user operation. Moreover, the terminal 2 saves text information, name, affiliation, and creation date information as intelligence information, in report X based on the user operation. In a case where the terminal 2 completes the creation of report X based on the user operation, it transmits report X and its identification information to the information processing device 1. In a case where the control unit 11 of the information processing device 1 completes the creation of report X based on the user operation, it performs a report issuing process (step S202). The control unit 11 instructs the transcription detection unit 13 to detect transcription. The transcription detection unit 13 detects transcription of citation information to a report based on the hash value of news X, satellite image X, or report A included in the data of report X, or on the acquisition of user operations. In a case where the transcription detection unit 13 detects transcription of citation information to report X, it generates a hash value of report X (step S203). Note that these processes of the information processing device 1 may be performed inside the terminal 2. The storage unit 14 associates the identification information of report X with the hash value, and stores them in a database or blockchain that is a storage destination (step S204). Moreover the storage unit 14 may also store the data of report X in a storage destination such as a database different from the hash value, in association with the identification information of the citation information of report X.

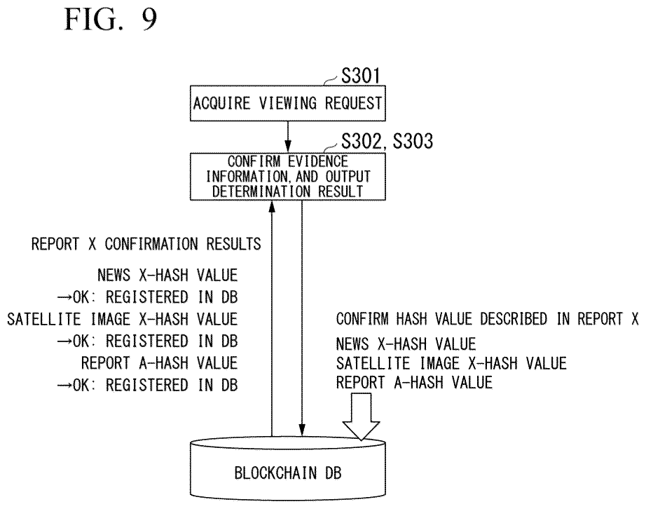

FIG. 9 is a third diagram showing the processing flow of the information processing system.

Next, a process in a case where a viewing user views report X will be described. The viewing user uses the terminal 2 to access the information processing system 100 and output a viewing request including the identification information of report X. The acquisition unit 12 of the information processing device 1 acquires the viewing request for the report (step S301). The acquisition unit 12 of the information processing device 1 acquires the report X from a storage destination such as a database or a blockchain based on the identification information. The acquisition unit 12 transmits the report X to the terminal 2 used by the viewing user. Moreover the acquisition unit 12 outputs the report X to the evidence information output unit 15. In a case where the evidence information output unit 15 detects a hash value of the evidence information in the report X, it determines whether or not the hash value is stored in the blockchain or database that is the storage destination (step S302). At this time, the evidence information output unit 15 determines whether or not the hash values of the news X, the satellite image X, and the report A included in the report X are recorded in the blockchain or the database. In a case where the hash values of the news X, the satellite image X, and the report A included in the report X are recorded in the blockchain or the database, the evidence information output unit 15 outputs a determination result of the evidence information indicating “OK: DB registered” for each, to the terminal 2 (step S303). If the hash values of news X, satellite image X, and report A included in report X are not recorded in the blockchain or database, the evidence information output unit 15 outputs the evidence information judgment result indicating “NG: not registered in DB” for each of them to the terminal 2. The terminal 2 outputs the evidence information judgment result to a display or the like. The evidence information output unit 15 may read information such as attributes of the cited information cited in the report (creation date and time, creator, and creating organization) from the blockchain or database as evidence information, and transmit it to the terminal 2, which then outputs it.

The above process allows the user to confirm the authenticity of the evidence of the cited information transcribed in the report. Therefore, the above process can further increase the authenticity of the information transcribed into a creation.

With the practical application of new technologies such as generative AI, fake information that is difficult to distinguish from the truth has flooded the Internet, making it difficult to verify the accuracy and credibility of information. For example, the same can be said for a satellite operation system that acquires images from an earth observation satellite and analyzes and distributes the results. Therefore, it is necessary to prove the accuracy of the information distributed by the system in order to increase the reliability and soundness of the entire system.

In a case where creating a report based on the findings of an investigation using images obtained from Earth observation satellites (hereafter referred to as satellite images) and their analysis results, the evidence for the report is currently not provided within the system. For this reason, each system user must separately identify information sufficient to guarantee authenticity, and manually attach it to the report being the final product. Even if the information is attached, it is done manually, so it cannot be said that the authenticity of the information is ensured.

Therefore, in the information processing system 100, within a satellite operation system consisting of multiple systems, the information that serves as the evidence for creating a report (information on satellite images and information on the report that is the evidence) and the information related to the creation of the report are stored and verified within the system using blockchain technology. This makes it possible to guarantee the authenticity of the information within the information processing system 100.

Furthermore, by storing the evidence information in the blockchain, the evidence information may be attached to reports and other creations as a Non-Fungible Token (NFT) and distributed. This allows the report viewer to verify the authenticity of the information source.

In the above process, the scope of information that can be referenced regarding the source of information may be changed depending on the report creator and the department to which the viewer belongs. For example, if the viewer and the creator are in the same department of the same organization, the name may be made viewable. Alternatively, if the viewer and the creator belong to different organizations, the name may be excluded from the viewable scope and the viewable scope may be limited to the department name. In this case, the evidence information output unit 15 may compare organizational information such as the department of the viewer and the report creator to determine whether they match, and if they do not match, the viewable scope may be limited and only the specified information may be sent to the terminal 2. The information processing system 100 may hold multiple past reports, and information such as reports to which past citation information has been transcribed, may be collectively stored in the blockchain or database.

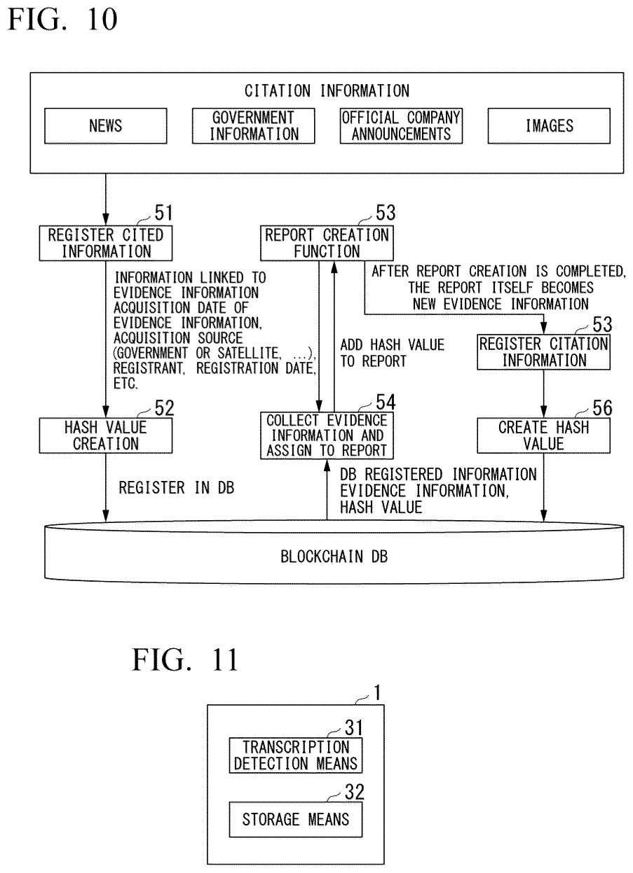

FIG. 10 shows an example of an information processing device with another configuration.

As shown in FIG. 10, the information processing device 1 may perform a process (51) of registering cited information such as news, government information, official corporate announcements, images, etc., a function (52) of generating and registering hash values as evidence information, a function (53) of creating reports and other creations, and a function (54) of collecting hash values as evidence information and assigning them to reports. The information processing device 1 may also have a function (55) of further registering the created report as citation information, and a function (56) of creating a hash value of a created item such as a report and registering the hash value.

FIG. 11 is a diagram showing another configuration of the information processing device.

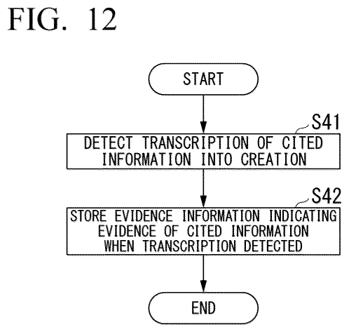

FIG. 12 is a diagram showing the processing flow of the information processing device in another example.

The information processing device 1 may have the functions of transcription detection means 31 and storage means 32.

The transcription detection means 31 detects the transcription of cited information into a creation (step S41).

The storage means 32 stores evidence information indicating the evidence of the cited information in a case where transcription is detected (step S42).

Although the present disclosure has been described above with reference to the example embodiments, the present disclosure is not limited to the above-mentioned example embodiments. Various changes that a person skilled in the art can understand within the scope of the present disclosure can be made to the configuration and details of the present disclosure. Furthermore, each of the above-mentioned example embodiments can be combined with other example embodiments as appropriate.

While preferred example embodiments of the disclosure have been described and illustrated above, it should be understood that these are example embodiments of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

A part or all of the above-mentioned example embodiments can be described as follows, but are not limited to the following.

### (Supplementary Note 1)

An information processing system comprising:
a transcription detection means that detects the transcription of citation information to a creation; and
a storage means that stores evidence information indicating an evidence of the citation information in a case where the transcription is detected.

### (Supplementary Note 2)

The information processing system described in supplementary note 1, wherein the citation information is an image,
and the evidence information is at least the photographing time of the image.

### (Supplementary Note 3)

The information processing system described in supplementary note 1 or supplementary note 2, wherein the citation information is literature information, and the evidence information is at least the creation time of the literature information.

### (Supplementary Note 4)

The information processing system according to any one of supplementary notes 1 to 3, wherein the creation is report information.

### (Supplementary Note 5)

The information processing system according to any one of supplementary notes 1 to 4, further comprising an evidence information output means that output the evidence information in a case where a request to view the creation is received.

### (Supplementary Note 6)

The information processing system according to any one of supplementary notes 1 to 5, wherein the storage means stores, as the evidence information, a hash value generated by inputting predetermined information included in the citation information into a hash function.

### (Supplementary Note 7)

The information processing system according to any one of supplementary notes 1 to 6, wherein the storage means stores the evidence information in a blockchain.

### (Supplementary Note 8)

The information processing system according to any one of supplementary notes 1 to 7, further comprising:
a determination means that, in a case where a request to view the creation is received, compares a hash value generated by inputting predetermined information included in the citation information transcribed to the creation into a hash function, with a stored hash value, to output a determination result of the evidence.

### (Supplementary Note 9)

An information processing device comprising:
a transcription detection means that detects the transcription of citation information to a creation; and
a storage means that stores evidence information indicating an evidence of the citation information in a case where the transcription is detected.

### (Supplementary Note 10)

The information processing device according to supplementary note 9, wherein the citation information is an image,
and the evidence information is at least the photographing time of the image.

### (Supplementary Note 11)

The information processing device according to supplementary note 9 or supplementary note 10, wherein the citation information is literature information, and the evidence information is at least the creation time of the literature information.

### (Supplementary Note 12)

The information processing device according to any one of supplementary notes 9 to 11, wherein the creation is report information.

### (Supplementary Note 13)

The information processing device according to any one of supplementary notes 9 to 12, further comprising an evidence information output means that outputs the evidence information in a case where a request to view the creation is received.

### (Supplementary Note 14)

The information processing device according to any one of supplementary notes 9 to 13, wherein the storage means stores, as the evidence information, a hash value generated by inputting predetermined information included in the citation information, into a hash function.

### (Supplementary Note 15)

The information processing device according to any one of supplementary notes 9 to 14, wherein the storage means stores the evidence information in a blockchain.

### (Supplementary Note 16)

The information processing device according to any one of supplementary notes 9 to 15, further comprising a determination means that, in a case where a request to view the creation is received, compares a hash value generated by inputting predetermined information included in the citation information transcribed to the creation into a hash function, with a stored hash value, to output a determination result of the evidence.

### (Supplementary Note 17)

A processing method executed by an information processing system comprising:
detecting the transcription of citation information to a creation; and
storing evidence information indicating the evidence of the citation information in a case where the transcription is detected.

### (Supplementary Note 18)

The processing method according to supplementary note 17, wherein the citation information is an image, and
the evidence information is at least a photographing time of the image.

### (Supplementary Note 19)

The processing method according to supplementary note 17 or supplementary note 18, wherein the citation information is literature information, and the evidence information is at least a creation time of the literature information.

### (Supplementary Note 20)

The processing method according to any one of supplementary notes 17 to 19, wherein the creation is report information.

### (Supplementary Note 21)

The processing method according to any one of supplementary notes 17 to 20, wherein the evidence information is output in a case where a request to view the creation is received.

### (Supplementary Note 22)

The processing method according to any one of supplementary notes 17 to 21, wherein a hash value generated by inputting predetermined information included in the citation information into a hash function is stored as the evidence information.

### (Supplementary Note 23)

The processing method according to any one of supplementary notes 17 to 22, wherein the evidence information is stored in a blockchain.

### (Supplementary Note 24)

The processing method according to any one of supplementary notes 17 to 23, wherein, in a case where a request to view the creation is received, compares a hash value generated by inputting predetermined information contained in the citation information transcribed to the creation into a hash function, with a stored hash value to output a determination result of the evidence.

### (Supplementary Note 25)

A program that causes a computer of an information processing device to function as
a transcription detection means that detects transcription of citation information to a creation, and as
a storage means that stores evidence information indicating the evidence of the citation information in a case where the transcription is detected.

### (Supplementary Note 26)

The program according to supplementary note 25, wherein the citation information is an image, and the evidence information is at least a photographing time of the image.

### (Supplementary Note 27)

The program according to supplementary note 25 or supplementary note 26, wherein the citation information is literature information, and
the evidence information is at least a creation time of the literature information.

### (Supplementary Note 28)

The program according to any one of supplementary notes 25 to 26, wherein the creation is report information.

### (Supplementary Note 29)

The program according to any one of supplementary notes 25 to 26, wherein the program functions as an evidence information output means that outputs the evidence information in a case where a request to view the creation is received.

### (Supplementary Note 30)

The program according to any one of supplementary notes 25 to 29, wherein the storage means stores, as the evidence information, a hash value generated by inputting predetermined information included in the citation information into a hash function.

### (Supplementary Note 31)

The program according to any one of supplementary notes 25 to 30, wherein the storage means stores the evidence information in a blockchain.

### (Supplementary Note 32)

The program according to any one of supplementary notes 25 to 31, which functions as
a determination means that, in a case where a request to view the creation is received, compares a hash value generated by inputting predetermined information included in the citation information transcribed to the creation into a hash function, with a stored hash value, to output a determination result of the evidence.

What is claimed is:

1. An information processing system comprising:
at least one memory configured to store instructions; and
at least one processor configured to execute the instructions to:
detect a transcription of citation information to a creation; and
store evidence information indicating an evidence of the citation information in a case where the transcription is detected.

2. The information processing system according to claim 1, wherein the citation information includes an image, and
wherein the evidence information includes at least a time when the image is taken.

3. The information processing system according to claim 1, wherein the citation information includes literature information, and
wherein the evidence information includes at least a time when the literature information is created.

4. The information processing system according to claim 1, wherein the creation includes report information.

5. The information processing system according to claim 2, wherein the creation includes report information.

6. The information processing system according to claim 3, wherein the creation includes report information.

7. The information processing system according to claim 4, wherein the at least one processor is configured to execute the instructions to output the evidence information in a case where a request to view the creation is received.

8. The information processing system according to claim 7, wherein the at least one processor is configured to execute the instructions to store a hash value generated by inputting predetermined information included in the citation information into a hash function, as the evidence information.

9. The information processing system according to claim 8, wherein the at least one processor is configured to execute the instructions to store the evidence information in a blockchain.

10. The information processing system according to claim 9, wherein the at least one processor is configured to execute the instructions to:
compare, in a case where a request to view the creation is received, a hash value generated by inputting predetermined information included in the citation information transcribed to the creation into a hash function, with the stored hash value; and
output a determination result of the evidence.

11. An information processing method executed by an information processing system, the information processing method comprising:
detecting a transcription of citation information to a creation; and
storing evidence information indicating an evidence of the citation information in a case where the transcription is detected.

12. The information processing method according to claim 11, wherein the citation information includes an image, and
wherein the evidence information includes at least a time when the image is taken.

13. The information processing method according to claim 11, wherein the citation information includes literature information, and
wherein the evidence information includes at least a time when the literature information is created.

14. The information processing method according to claim 11, wherein the creation includes report information.

15. The information processing method according to claim 12, wherein the creation includes report information.

16. The information processing method according to claim 14, further comprising outputting the evidence information in a case where a request to view the creation is received.

17. The information processing method according to claim 16, further comprising storing a hash value generated by inputting predetermined information included in the citation information into a hash function, as the evidence information.

18. The information processing method according to claim 17, further comprising storing the evidence information in a blockchain.

19. The information processing method according to claim 18, further comprising:
comparing, in a case where a request to view the creation is received, a hash value generated by inputting predetermined information included in the citation information transcribed to the creation into a hash function, with the stored hash value; and
outputting a determination result of the evidence.

20. A non-transitory storage medium storing a program that causes a computer of an information processing device to execute:
detecting a transcription of citation information into a creation, and
storing evidence information indicating an evidence of the citation information in a case where the transcription is detected.
